(19) United States
(12) Patent Application Publication
(10) Pub. No.: US 2022/0140440 A1
(43) Pub. Date: May 5, 2022

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Byung-Soo KIM, Yongin-si (KR); Yeonho LEE, Yongin-si (KR); Namju KIM, Yongin-si (KR); Jaehyun CHO, Yongin-si (KR)

(21) Appl. No.: 17/500,091

(22) Filed: Oct. 13, 2021

(30) Foreign Application Priority Data
Oct. 30, 2020 (KR) 10-2020-0143748

(51) Int. Cl. H01M 50/454; H01M 10/0525; H01M 50/446; H01M 50/443; C09D 129/04; C09D 139/06; C09D 7/61

(52) U.S. Cl. CPC H01M 50/454; H01M 10/0525; H01M 50/446; H01M 2220/20; C09D 129/04; C09D 139/06; C09D 7/61; H01M 50/443

(57) ABSTRACT

A separator for a rechargeable lithium battery and a rechargeable lithium battery, the separator including a porous substrate; and a coating layer on at least one surface of the porous substrate coating layer on at least one surface of the porous substrate, wherein the coating layer includes a binder resin and inorganic particles, the binder resin includes a first polymer including a structural unit represented by Chemical Formula 1 and a second polymer including a structural unit represented by Chemical Formula 2, and a weight ratio of the first polymer and the second polymer in the binder resin is about 35:65 to about 75:25,

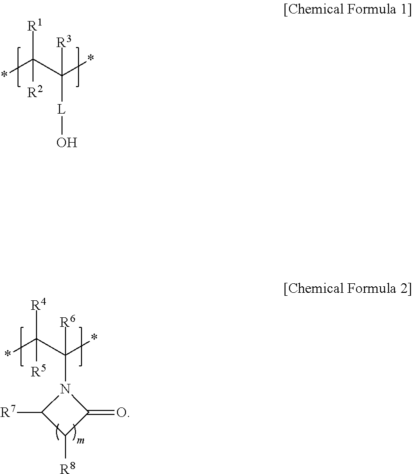

### CROSS-REFERENCE TO RELATED APPLICATION

Korean Patent Application No. 10-2020-0143748, filed on Oct. 30, 2020 in the Korean Intellectual Property Office, and entitled: “Separator for Rechargeable Lithium Battery and Rechargeable Lithium Battery Including the Same,” is incorporated by reference herein in its entirety.

### BACKGROUND OF THE INVENTION

### 1. Field

Embodiments relate to a separator for a rechargeable lithium battery and a rechargeable lithium battery including the same.

### 2. Description of the Related Art

Recently, research on a rechargeable lithium battery has been actively made, as the desirability of a battery having high energy density as a power source for a portable electronic device is increased. In addition, an electric vehicle and the like has been considered with an increasing interest in environmental problems, research on the rechargeable lithium battery as a power source for the electric vehicle has been actively made.

A rechargeable lithium battery may include a positive electrode, a negative electrode, and a separator between the positive and negative electrodes. The separator may electrically insulate the positive and negative electrodes, and may include micropores through which lithium ions move.

### SUMMARY

The embodiments may be realized by providing a separator for a rechargeable lithium battery, the separator including a porous substrate; and a coating layer on at least one surface of the porous substrate, wherein the coating layer includes a binder resin and inorganic particles, the binder resin includes a first polymer including a structural unit represented by Chemical Formula 1 and a second polymer including a structural unit represented by Chemical Formula 2, and a weight ratio of the first polymer and the second polymer in the binder resin is about 35:65 to about 75:25,

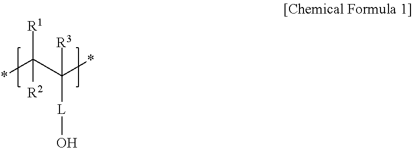

in Chemical Formula 1, R¹ to R³ are each independently hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group, and L is a single bond or a substituted or unsubstituted C1 to C10 alkylene group,

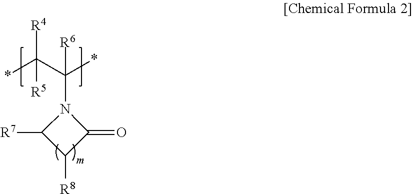

in Chemical Formula 2, R⁴ to R⁸ are each independently hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group, and m is an integer of 1 to 10.

R¹ to R³ in Chemical Formula 1 may each independently be hydrogen, deuterium, a halogen, or a substituted or unsubstituted C1 to C5 alkyl group.

R⁴ to R⁸ in Chemical Formula 2 may each independently be hydrogen, deuterium, a halogen, or a substituted or unsubstituted C1 to C5 alkyl group, and m may be 1 or 2.

A weight ratio of the first polymer and the second polymer in the binder resin may be about 40:60 to about 70:30.

The coating layer may have a thickness of about 1 μm to about 10 μm.

The binder resin may be included in the coating layer in an amount of about 1 wt % to about 20 wt %, based on a total weight of the binder resin and the inorganic particles.

The binder resin may further include an additional binder, the additional binder including a (meth)acrylic polymer, a styrene polymer, a fluorine polymer, or a combination thereof.

The inorganic particles may be included in the coating layer in an amount of about 80 wt % to about 99 wt %, based on a total weight of the binder resin and the inorganic particles.

The inorganic particles may include Al₂O₃, B₂O₃, Ga₂O₃, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The porous substrate may include polyolefin, polyester, polytetrafluoroethylene, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalene, a glass fiber, or a combination thereof.

After leaving the separator at about 130° C. to about 150° C. for 60 minutes, measured average shrinkage rates in a machine direction and a transverse direction may be less than or equal to about 20%.

The embodiments may be realized by providing a rechargeable lithium battery including a positive electrode; a negative electrode; and the separator for a rechargeable lithium battery according to an embodiment between the positive electrode and the negative electrode.

### BRIEF DESCRIPTION OF THE DRAWING

Features will be apparent to those of skill in the art by describing in detail exemplary embodiments with reference to the attached drawing in which:

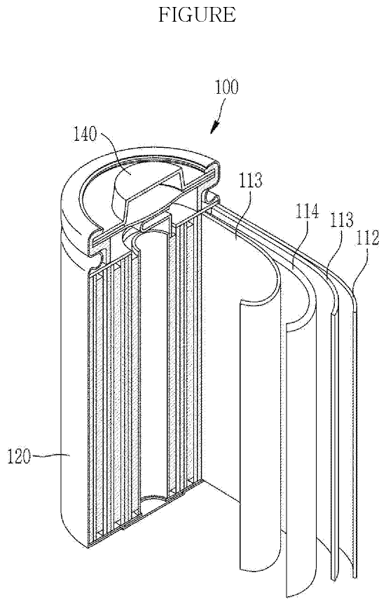

The FIG. 1s an exploded perspective view of a rechargeable lithium battery according to one embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, when a definition is not otherwise provided, “substituted” means that a hydrogen atom in a compound is replaced by a substituent other than hydrogen.

The term “substituted” refers to replacement of a hydrogen atom of a compound or a functional group by a substituent, e.g., a halogen atom (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, or a combination thereof. As used herein, the term “or” is not an exclusive term, e.g., “A or B” would include A, B, or A and B.

In an embodiment, “substituted” refers to replacement of a hydrogen atom of a compound by a phthalate group, an isocyanate group, a urethane group, a (meth)acrylate group, an epoxy group, or a melamine group.

As used herein, when a definition is not otherwise provided, “hetero” refers to one including 1 to 3 heteroatoms selected from N, O, S, and P.

As used herein, “(meth)acrylic” refers to acryl and/or methacrylic.

As used herein, when a definition is not otherwise provided, “combination thereof” refers to a mixture, a copolymer, a blend, an alloy, a composite, a reaction product of components. As used herein, in the Chemical Formulae, “*” represents a linking point with another atom.

Hereinafter, a separator for a rechargeable lithium battery according to an embodiment is described.

The separator for a rechargeable lithium battery according to the present embodiment may separate a negative electrode and a positive electrode and may provide a transporting passage for lithium ions. The separator may include a porous substrate and a coating layer on at least one surface of the porous substrate.

The porous substrate may be a substrate including pores, and lithium ions may move through the pores. The porous substrate may include, e.g., polyolefin, polyester, polytetrafluoroethylene (PTFE), polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalene, a glass fiber, or a combination thereof. Examples of the polyolefin may include polyethylene, polypropylene, or the like, and examples of the polyester may include polyethyleneterephthalate, polybutyleneterephthalate, or the like. In an implementation, the porous substrate may be a non-woven fabric or a woven fabric. The porous substrate may have a single layer or multilayer structure. In an implementation, the porous substrate may be a polyethylene single layer, a polypropylene single layer, a polyethylene/polypropylene double layer, a polypropylene/polyethylene/polypropylene triple layer, a polyethylene/polypropylene/polyethylene triple layer, or the like. A thickness of the porous substrate may be about 1 μm to about 40 μm, e.g., about 1 μm to about 30 μm, about 1 μm to about 20 μm, about 5 μm to about 20 μm, or about 5 μm to about 10 μm. When the thickness of the substrate is within the range, short-circuit between positive and negative electrodes may be prevented without increasing internal resistance of a battery.

The coating layer may be formed on one surface or both surfaces of the porous substrate and may include a binder resin and inorganic particles.

The binder resin may include a first polymer including a repeating or structural unit represented by Chemical Formula 1 and a second polymer including a repeating or structural unit represented by Chemical Formula 2.

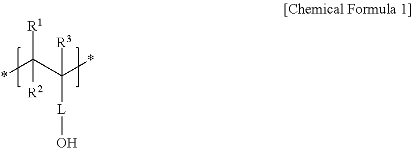

In Chemical Formula 1, R¹ to R³ may each independently be or include, e.g., hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group.

L may be or include, e.g., a single bond or a substituted or unsubstituted C1 to C10 alkylene group.

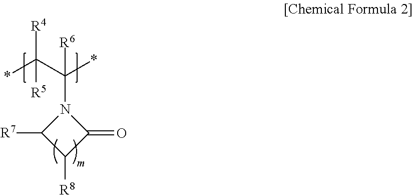

In Chemical Formula 2, R⁴ to R⁸ may each independently be or include, e.g., hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group.

m may be, e.g., an integer of 1 to 10.

In an implementation, le to R³ in Chemical Formula 1 may each independently be, e.g., hydrogen, deuterium, a halogen group, or a substituted or unsubstituted C1 to C5 alkyl group. In an implementation, the first polymer may include a structural unit represented by Chemical Formula 1-1.

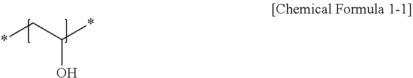

In an implementation, R⁴ to R⁸ in Chemical Formula 2 may each independently be, e.g., hydrogen, deuterium, a halogen, or a substituted or unsubstituted C1 to C5 alkyl group, and m may be, e.g., 1 or 2. In an implementation, the second polymer may include a structural unit represented by Chemical Formula 2-1.

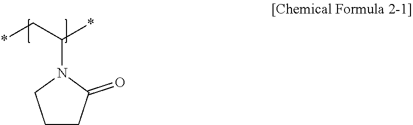

The binder resin may be formed by mixing the first polymer and the second polymer in a weight ratio of about 35:65 to about 75:25, e.g., about 40:60 to about 70:30. In an implementation, by forming a binder resin including the first polymer and the second polymer in the above range on the coating layer on the porous substrate, heat resistance and mechanical properties may be improved. In an implementation, a rechargeable lithium battery having enhanced thermal stability may be implemented. Maintaining the amount of the first polymer in the binder resin at about 35 parts by weight or greater (e.g., based on 100 parts by weight of the first polymer and the second polymer) may help ensure that an appearance problem (in which the coating layer is coated unevenly) may be avoided. Maintaining the amount of the first polymer in the binder resin at about 75 parts by weight or less (e.g., based on 100 parts by weight of the first polymer and the second polymer) may help prevent an increase in air permeability and thus may help prevent an increase in resistance. In an implementation, the first polymer and the second polymer may be included in the binder resin in substantially different amounts, e.g., not in a 1:1 weight ratio.

A weight average molecular weight of the first polymer included in the binder resin may be about 5,000 g/mol to about 50,000 g/mol, e.g., about 15,000 g/mol to about 25,000 g/mol. A weight average molecular weight of the second polymer may be about 50,000 g/mol to about 100,000 g/mol, e.g., about 50,000 g/mol to about 70,000 g/mol. When the molecular weight of the binder resin is within the above ranges, a separator having excellent heat resistance and mechanical strength may be secured, and accordingly, a rechargeable lithium battery having excellent thermal stability and improved cycle-life characteristics and safety may be achieved by improving adherence to the substrate.

The coating layer may have a thickness of about 1 μm to about 10 μm, e.g., about 1 μm to about 8 μm, about 1 μm to about 6 μm, or about 2 μm to about 6 μm. When the thickness of the coating layer is within the above ranges, heat resistance may be improved, so that a short circuit inside the battery may be suppressed, a stable separator may be secured, and an increase in internal resistance of the battery may be suppressed.

In an implementation, the binder resin may be included (in the coating layer) in an amount of about 1 wt % to about 20 wt %, e.g., about 1 wt % to about 15 wt %, about 1 wt % to about 10 wt %, or about 2 wt % to about 10 wt %, or about 1 wt % to about 5 wt %, based on a total weight of the binder resin and the inorganic particles. In this case, a separator having excellent heat resistance and mechanical strength may be secured, and accordingly, a rechargeable lithium battery having excellent thermal stability and improved cycle-life characteristics and safety may be implemented by improving adherence to the substrate.

In an implementation, the coating layer may further include a dispersant.

The dispersant may include a silane coupling agent or a carboxyl polymer. In an implementation, the dispersant may include 3-methacryloxypropyltrimethoxysilane or polycarboxylic acid.

By further including the dispersant, a compatibility of the binder resin and the inorganic particles in the composition for forming the coating layer may be increased, thereby facilitating the formation of a uniform coating layer and helping to provide uniform physical properties of the coated separator.

The dispersant may be included in an amount of about 0.1 to about 5 parts by weight, e.g., about 1 to about 3 parts by weight, based on 100 parts by weight of the binder resin and the inorganic particles.

When amount of the dispersant is within the above ranges, the effect of planarizing the surface roughness may be exhibited, thereby ensuring uniform cell characteristics of the battery.

In an implementation, the binder resin may further include an additional binder, in addition to the first polymer and the second polymer. In an implementation, the additional binder may include, e.g., a (meth)acrylic polymer, a styrene polymer, a fluorine polymer, or a combination thereof. In an implementation, the (meth)acrylic polymer may include, e.g., polyacrylamide, polymethacrylate, polyethylacrylate, polyacrylate, polybutylacrylate, sodium polyacrylate, or an acrylic acid-methacrylic acid copolymer. In an implementation, the styrene polymer may include, e.g., polystyrene, polyalphamethylstyrene, or polybromostyrene. In an implementation, the fluorine polymer may include, e.g., polyvinylidene fluoride, polytetrafluoroethylene, polyhexafluoropropylene, hexafluoropropylene, polyvinylidene fluoride-hexafluoro propylene, or polychlorotrifluoroethylene, or a mixture of two or more thereof.

The additional binder may be included in an amount of about 1 to about 40 parts by weight, e.g., about 1 to about 30 parts by weight, about 5 to about 30 parts by weight, or about 10 to about 30 parts by weight, based on 100 parts by weight of the binder resin included in the coating layer. When the amount of the additional binder is within the above ranges, heat resistance may be improved by appropriately adjusting physical properties of the coating layer.

When the additional binder is further included in the coating layer, e.g., the coating layer may include 0.1 wt % to 9 wt % of the binder resin including the first polymer and the second polymer, 0.1 wt % to 5 wt % of the additional binder, and 90 wt % to 99 wt % of the inorganic particles. In this case, a separator having excellent heat resistance and mechanical strength may be secured, and accordingly, a rechargeable lithium battery having excellent thermal stability and improved cycle-life characteristics and safety may be implemented by improving adherence to the substrate.

In an implementation, the inorganic particles may be included (in the coating layer) in an amount of about 80 wt % to about 99 wt %, e.g., about 85 wt % to about 99 wt %, about 90 wt % to about 99 wt %, about 90 wt % to about 98 wt %, or about 95 wt % to about 99 wt %, based on the total weight of the coating layer, e.g., based on the total weight of the binder resin and the inorganic particles. When the inorganic particles are included within the above range, battery performance may be improved by preventing contraction of the substrate due to heat and suppressing a short circuit between the positive and negative electrodes.

In an implementation, the inorganic particles may include, e.g., Al₂O₃, B₂O₃, Ga₂O₃, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The inorganic particles may have an average particle diameter ranging from about 100 nm to about 2,000 nm, e.g., about 100 nm to about 1,000 nm, or about 150 nm to about 750 nm. In an implementation, two or more types of inorganic particles having different particle diameters may be mixed and used. When the inorganic particles have an average particle diameter within the ranges, the coating layer may be uniformly coated on the substrate and suppress a short circuit between the positive and negative electrodes and in addition, minimize resistance of lithium ions to secure performance of a rechargeable lithium battery.

In the present specification, the average particle diameter may be a particle size (D₅₀) at 50% by volume in a cumulative size-distribution curve.

In an implementation, after leaving the separator at about 130° C. to about 150° C. for 60 minutes, measured average shrinkage rates in a machine direction (MD) and a transverse direction (TD) may be less than or equal to about 20%, e.g., less than or equal to about 15%, less than or equal to about 11%, less than or equal to about 9%, less than or equal to about 6%, or less than or equal to about 4%. In an implementation, the separator may have sufficiently strong adherence between the coating layer and the porous substrate to help suppress shrinkage of the porous substrate due to heat, as well as prevent separation between the coating layer and the porous substrate, which could otherwise occur when the battery is overheated. A method of measuring the heat shrinkage rate of the separator may be a suitable method. An example of a method of measuring the heat shrinkage rate may be as follows: The prepared separator may be cut into a size of about 15 cm in width (MD) and about 15 cm in length (TD), and it may be stored in a chamber at 150° C. for 60 minutes, shrinkage degrees of in the machine direction (MD) and the transverse direction (TD) of the separator may be measured to calculate the heat shrinkage rates.

The separator for a rechargeable lithium battery according to an embodiment may be manufactured by suitable methods. In an implementation, a separator for a rechargeable lithium battery may be formed by coating a composition for forming a coating layer to one surface or both surfaces of a porous substrate and then drying.

The composition for forming the coating layer may include a binder resin including the first polymer including the structural unit represented by Chemical Formula 1 and the second polymer including the structural unit represented by Chemical Formula 2, inorganic particles, an initiator, and a solvent.

First, the composition for forming the coating layer including the binder resin, inorganic particles, the dispersant, and the solvent may be coated to or on at least one surface of a substrate.

In an implementation, the composition for forming the coating layer may be prepared by mixing a binder resin, inorganic particles, a dispersant, and a solvent and stirring at about 10° C. to about 40° C. for about 30 minutes to about 5 hours. Herein, a binder resin solution may be prepared by mixing 2 to 10 wt % of a binder resin in which the first polymer and the second polymer are mixed in a weight ratio of 35:65 to 75:25, and a balance amount of the solvent; the inorganic dispersion is prepared by mixing 80 wt % to 99 wt % of the inorganic particles and a balance amount of the solvent; and the binder resin solution and the inorganic dispersion may be mixed at room or ambient temperature for 30 minutes to 5 hours.

The solvent may include an alcohol, e.g., methanol, ethanol, isopropyl alcohol, or the like; a ketone, e.g., acetone or the like, water, or the like. In an implementation, the solvent may include a suitable solvent that dissolves the first polymer and second polymer.

The stirring may be performed with a ball mill, a beads mill, a screw mixer, or the like.

A method of coating the composition for forming a coating layer may include dip coating, die coating, roll coating, comma coating, spray coating, Meyer bar coating, Gravure coating, or at least two coating methods among them.

In an implementation, after coating the composition for forming a coating layer, a drying process may be further performed. The drying process may be performed at a temperature of about 80° C. to about 100° C. for about 5 seconds to 60 seconds, and batch or continuous drying may be applicable.

The formation of the coating layer on the substrate may be performed by a method such as lamination or coextrusion in addition to the coating method using the composition for forming a coating layer.

Hereinafter, a rechargeable lithium battery including the separator for the rechargeable lithium battery is described.

A rechargeable lithium battery may include, e.g., a lithium ion battery, a lithium ion polymer battery, or a lithium polymer battery, depending on kinds of a separator and an electrolyte. A rechargeable lithium battery may be, e.g., cylindrical, prismatic, a coin-type, a pouch-type, or the like, depending on its shape. In an implementation, it may be bulk type and thin film type, depending on sizes. Structures and manufacturing methods for lithium ion batteries may be suitable structures and manufacturing methods.

Herein, as an example of a rechargeable lithium battery, a cylindrical rechargeable lithium battery is exemplarily described. The FIG. 1s an exploded perspective view of a rechargeable lithium battery according to an embodiment. Referring to the FIGURE, a rechargeable lithium battery 100 according to one embodiment may include a battery cell including a negative electrode 112, a positive electrode 114 facing the negative electrode 112, a separator 113 between the negative electrode 112 and the positive electrode 114, and an electrolyte impregnating the negative electrode 112, the positive electrode 114 and the separator 113, and a battery container 120, a battery case containing the battery cell, and a sealing member 140 that seals the container 120.

The positive electrode 114 may include a positive current collector and a positive active material layer on the positive current collector. The positive active material layer includes a positive active material, a binder, and optionally a conductive material.

The positive current collector may include aluminum (Al), nickel (Ni), or the like.

The positive active material may include a compound capable of intercalating and deintercallating lithium. In an implementation, a composite oxide or a composite phosphate of a metal selected from cobalt, manganese, nickel, aluminum, iron, or a combination thereof and lithium, may be used. In an implementation, the positive active material may include lithium cobalt oxide, lithium nickel oxide, lithium manganese oxide, lithium nickel cobalt manganese oxide, lithium nickel cobalt aluminum oxide, lithium iron phosphate, or a combination thereof.

The binder may help improve binding properties of positive active material particles with one another and with a current collector. Examples may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like. These may be used alone or as a mixture of two or more.

The conductive material may help improve conductivity of an electrode. Examples thereof may include natural graphite, artificial graphite, carbon black, a carbon fiber, a metal powder, a metal fiber, or the like. These may be used alone or as a mixture of two or more. The metal powder and the metal fiber may include a metal, e.g., copper, nickel, aluminum, silver, or the like.

The negative electrode 112 may include a negative current collector and a negative active material layer on the negative current collector.

The negative current collector may include, e.g., copper, gold, nickel, a copper alloy.

The negative active material layer may include a negative active material, a binder, and optionally a conductive material. The negative active material may include a material that reversibly intercalates/deintercalates lithium ions, a lithium metal, a lithium metal alloy, a material capable of doping and dedoping lithium, a transition metal oxide, or a combination thereof.

The material that reversibly intercalates/deintercalates lithium ions may include a suitable carbon material, e.g., crystalline carbon, amorphous carbon, or a combination thereof. Examples of the crystalline carbon may include graphite such as amorphous, sheet-shaped, flake-shaped, spherically, shaped or fiber-shaped natural graphite or artificial graphite. Examples of the amorphous carbon may include soft carbon or hard carbon, a mesophase pitch carbonized product, fired coke, or the like. The lithium metal alloy may be an alloy of lithium and, e.g., Na, K, Rb, Cs, Fr, Be, Mg, Ca, Sr, Si, Sb, Pb, In, Zn, Ba, Ra, Ge, Al, or Sn. The material capable of doping and dedoping lithium may be, e.g., Si, SiOₓ (0<x<2), a Si—C composite, a Si—Y alloy, Sn, SnO₂, a Sn—C composite, a Sn—Y alloy, or the like, and at least one of these may be mixed with SiO₂. The element Y may be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof. The transition metal oxide may be vanadium oxide, lithium vanadium oxide, or the like.

The binder and the conductive material used in the negative electrode 112 may be the same as the binder and conductive material of the positive electrode 114.

The positive electrode 114 and the negative electrode 112 may be manufactured by mixing each active material composition including each active material and a binder, and optionally a conductive material in a solvent, and coating the active material composition on each current collector. In an implementation, the solvent may include N-methylpyrrolidone or the like.

The electrolyte may include an organic solvent and a lithium salt.

The organic solvent may serve as a medium for transmitting ions taking part in the electrochemical reaction of a battery. Examples thereof may include a carbonate solvent, an ester solvent, an ether solvent, a ketone solvent, an alcohol solvent, or an aprotic solvent. The carbonate solvent may include dimethyl carbonate, diethyl carbonate, dipropyl carbonate, methylpropyl carbonate, ethylpropyl carbonate, methylethyl carbonate, ethylene carbonate, propylene carbonate, butylene carbonate, or the like, and the ester solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, or the like. The ether solvent may include dibutyl ether, tetraglyme, diglyme, dimethoxyethane, 2-methyltetrahydrofuran, tetrahydrofuran, or the like, and the ketone solvent may include cyclohexanone or the like. The alcohol solvent may include ethanol, isopropyl alcohol, or the like, and the aprotic solvent may include nitriles such as R—CN (R is a C2 to C20 linear, branched, or cyclic hydrocarbon group, a double bond, an aromatic ring, or an ether bond), and the like, amides such as dimethyl formamide, dioxolanes such as 1,3-dioxolane, sulfolanes, or the like.

The organic solvent may be used alone or in a mixture of two or more, and when the organic solvent is used in a mixture of two or more, the mixture ratio may be controlled in accordance with a desirable cell performance.

The lithium salt may be dissolved in an organic solvent, may supply lithium ions in a battery, may contribute to basic operation of the rechargeable lithium battery, and may help improve lithium ion transportation between positive and negative electrodes therein. Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N ((lithium bis(fluorosulfonyl)imide, LiFSI), LiC₄F₉SO₃, LiClO₄, LiAlO₂, LiAlCl₄, LiN(CₓF₂ₓ₊₁SO₂)(C_{y}F_{2y+1}SO₂), wherein, x and y are natural numbers, e.g. an integer of 1 to 20, LiCl, LiI, and LiB(C₂O₄)₂ (lithium bis(oxalato) borate, LiBOB).

The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

(Preparation of Separators)

### Example 1

A binder resin solution was prepared by mixing a first polymer including a structural unit represented by Chemical Formula 1-1 (KURARAY Co., Ltd.) and a second polymer including a structural unit represented by a Chemical Formula 2-1 (Ashland) in a weight ratio of 40:60, adding 20 parts by weight of an acrylate binder (BM-930B, Zeon Chemicals L.P.) based on a total weight of the first and second polymers, diluting the obtained mixture to 30 wt % with DI-water, and stirring the diluted solution at 25° C. for 1 hour with a stirrer.

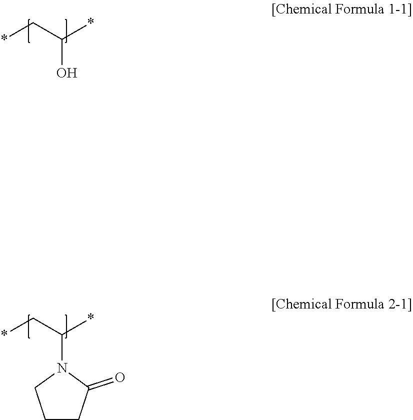

In addition, boehmite (γ-AlO(OH), Nabaltec AG) was pulverized with a bead mill, and then, 30 wt % of the pulverized boehmite and 70 wt % of DI-water were mixed at 25° C. for 4 hours to obtain inorganic dispersion.

The inorganic dispersion was mixed with the binder resin solution to include 95 wt % of the boehmite and then, stirred with a power mixer at 25° C. for 1 hour to prepare a composition for forming a coating layer.

The prepared composition for forming a coating layer was coated on one surface of a 9 μm-thick polyethylene single film (W-Scope Corp.) in a gravure coating method and then, dried at 80° C. for 2 minutes to form a 13 μm-thick separator having a coating thickness of 4 μm.

### Examples 2 to 4

Separators were manufactured according to the same method as Example 1 except that the first polymer including the structural unit represented by Chemical Formula 1-1 (KURARAY Co., Ltd.) and the second polymer including the structural unit represented by Chemical Formula 2-1 (Ashland) were used in each weight ratio shown in Table 1.

### Comparative Examples 1 to 5

Separators were manufactured according to the same method as Example 1 except that the first polymer including the structural unit represented by Chemical Formula 1-1 (KURARAY Co., Ltd.) and the second polymer including the structural unit represented by Chemical Formula 2-1 (Ashland) were used in each weight ratio shown in Table 1.

The compositions for forming a coating layer according to the Examples and the Comparative Examples were prepared to have each composition shown in Table 1.

TABLE 1

| | First | Second | Acrylic | | First polymer: |
|---|---|---|---|---|---|
| | polymer | polymer | binder | Boehmite | second polymer |
| | (wt %) | (wt %) | (wt %) | (wt %) | (weight ratio) |
| Example 1 | 1.6 | 2.4 | 1 | 95 | 40:60 |
| Example 2 | 2 | 2 | 1 | 95 | 50:50 |
| Example 3 | 2.4 | 1.6 | 1 | 95 | 60:40 |
| Example 4 | 2.8 | 1.2 | 1 | 95 | 70:30 |
| Comparative | 0.4 | 3.6 | 1 | 95 | 10:90 |
| Example 1 | | | | | |
| Comparative | 0.8 | 3.2 | 1 | 95 | 20:80 |
| Example 2 | | | | | |
| Comparative | 1.2 | 2.8 | 1 | 95 | 30:70 |
| Example 3 | | | | | |
| Comparative | 3.2 | 0.8 | 1 | 95 | 80:20 |
| Example 4 | | | | | |
| Comparative | 3.6 | 0.4 | 1 | 95 | 90:10 |
| Example 5 | | | | | |

### EVALUATION EXAMPLES

### Evaluation Example 1: Measurement of Coating Layer Thickness

The separators for a rechargeable lithium battery according to Examples 1 to 4 and Comparative Examples 1 to 5 were measured with respect to a thickness by using a film thickness meter (ID-C112XBS, Mitutoyo Corp.), and the results are shown in Table 2.

### Evaluation Example 2: Air Permeability

Each time (seconds) until the separators for a rechargeable battery according to Examples 1 to 4 and Comparative Examples 1 to 5 passed 100 cc of air was measured by using an air permeability measuring device (EG01-55-1MR, Asahi Seiko Co., Ltd.), and the results are shown in Table 2.

### Evaluation Example 3: Substrate-Binding Force

The separators for a rechargeable lithium battery according to Examples 1 to 4 and Comparative Examples 1 to 5 were evaluated with respect to a binding force between a porous substrate and a coating layer by attaching a tape (3M) in a width of 12 mm×a length of 150 mm to each specimen and uniformly pressing them with a hand roller. The test specimens were cut to be 2.0 mm larger than the tape size. After fixing each test specimen to upper/lower grips, UTM (INSTRON) was used to three times measure peel strength from 10 mm to 40 mm, while peeled off in a direction of 180° at a tensile speed of 20 mm/min, and the measurements were averaged. The results are shown in Table 2.

### Evaluation Example 4: Evaluation of Heat Resistance

The separators of Examples 1 to 4, and Comparative Examples 1 to 5 were evaluated with respect to heat resistance by measuring a shrinkage rate against heat in the following method, and the results are shown in Table 2.

Each sample of the separators was cut into a size of 10 cm×10 cm and allowed to stand in a convection oven set at 130° C. or 150° C. for 60 minutes to measure each shrinkage rate in MD (machine direction) and TD (transverse direction). The shrinkage rate was calculated according to Equation 1.

Shrinkage rate(%)=[(L0−L1)/L0]×100 [Equation 1]

In Equation 1, L0 denotes an initial length of a separator, and L1 denotes a length of the separator after being left at 130° C. or 150° C. for 60 minutes.

### Evaluation Example 5: Evaluation of Separator Appearance

As a result of examining appearance of the separators according to Examples 1 to 4 with naked eyes, there were no appearance problems such as agglomeration and separation of a coating layer, uncoating, and the like.

TABLE 2

| | Properties | | | | | |
|---|---|---|---|---|---|---|
| | Coating | Air | Substrate- | | Shrinkage rate (%) | |
| | thickness | permeability | binding | Separator | 130° C./ | 150° C./ |
| | (μm) | (sec/100 cc) | force (N/mm) | appearance | 1 hr | 1 hr |
| Ex. 1 | 4.0 | 155 | 1.0 | good | 6 | 11 |
| Ex. 2 | 3.9 | 151 | 1.1 | good | 2 | 9 |
| Ex. 3 | 3.8 | 157 | 1.8 | good | 2 | 3 |
| Ex. 4 | 3.9 | 161 | 2.0 | good | 2 | 4 |
| Comp. Ex. 1 | 3.9 | 152 | 0.1 | inferior | 19 | 52 |
| Comp. Ex. 2 | 3.9 | 155 | 0.2 | good | 21 | 49 |
| Comp. Ex. 3 | 3.8 | 153 | 0.2 | good | 13 | 43 |
| Comp. Ex. 4 | 4.0 | 211 | 0.7 | inferior | 17 | 34 |
| Comp. Ex. 5 | 4.0 | 310 | 0.4 | inferior | 22 | 54 |

Referring to Table 2, the separators according to Examples 1 to 4 exhibited better appearance and excellent substrate-binding force and heat resistance, as well as excellent air permeability, compared with the separators according to Comparative Examples 1 to 5.

By way of summation and review, a separator may exhibit excellent battery stability about exothermicity, as a battery tends to be lighter and down-sized and may maintain high capacity as a power source having high power/large capacity for the electric vehicle.

A separator may be formed by coating a binder resin and a ceramic particle on a porous substrate. Such a separator may rarely secure stability due to shrinkage during overheating of the battery.

One or more embodiments may provide a separator for a rechargeable lithium battery that simultaneously secures heat resistance and mechanical properties and has excellent air permeability, substrate-binding force, and appearance.

One or more embodiments may provide a rechargeable lithium battery having excellent safety, capacity characteristics, cycle-life characteristics, and the like, by including the separator.

A rechargeable lithium battery having excellent thermal safety may be implemented by including the separator for a rechargeable lithium battery having high heat resistance and mechanical properties, and excellent air permeability, substrate-binding force, and appearance.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable lithium battery, the separator comprising:
a porous substrate; and
a coating layer on at least one surface of the porous substrate,
wherein:
the coating layer includes a binder resin and inorganic particles,
the binder resin includes a first polymer including a structural unit represented by Chemical Formula 1 and a second polymer including a structural unit represented by Chemical Formula 2, and
a weight ratio of the first polymer and the second polymer in the binder resin is about 35:65 to about 75:25, 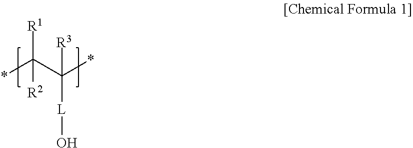
in Chemical Formula 1,
R¹ to R³ are each independently hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group, and
L is a single bond or a substituted or unsubstituted C1 to C10 alkylene group, 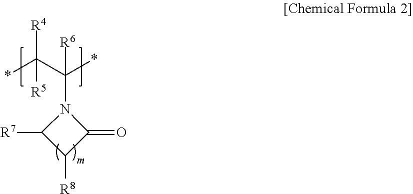
in Chemical Formula 2,
R⁴ to R⁸ are each independently hydrogen, deuterium, a halogen, a substituted or unsubstituted C1 to C10 alkyl group, a substituted or unsubstituted C1 to C10 heteroalkyl group, a substituted or unsubstituted C6 to C20 aryl group, or a substituted or unsubstituted C1 to C20 heteroaryl group, and
m is an integer of 1 to 10.

2. The separator as claimed in claim 1, wherein R¹ to R³ in Chemical Formula 1 are each independently hydrogen, deuterium, a halogen, or a substituted or unsubstituted C1 to C5 alkyl group.

3. The separator as claimed in claim 1, wherein:
R¹ to R³ in Chemical Formula 2 are each independently hydrogen, deuterium, a halogen, or a substituted or unsubstituted C1 to C5 alkyl group, and
m is 1 or 2.

4. The separator as claimed in claim 1, wherein a weight ratio of the first polymer and the second polymer in the binder resin is about 40:60 to about 70:30.

5. The separator as claimed in claim 1, wherein the coating layer has a thickness of about 1 μm to about 10 μm.

6. The separator as claimed in claim 1, wherein the binder resin is included in the coating layer in an amount of about 1 wt % to about 20 wt %, based on a total weight of the binder resin and the inorganic particles.

7. The separator as claimed in claim 1, wherein the binder resin further includes an additional binder, the additional binder including a (meth)acrylic polymer, a styrene polymer, a fluorine polymer, or a combination thereof.

8. The separator as claimed in claim 1, wherein the inorganic particles are included in the coating layer in an amount of about 80 wt % to about 99 wt %, based on a total weight of the binder resin and the inorganic particles.

9. The separator as claimed in claim 1, wherein the inorganic particles include Al₂O₃, B₂O₃, Ga₂O₃, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

10. The separator as claimed in claim 1, wherein the porous substrate includes polyolefin, polyester, polytetrafluoroethylene, polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylene sulfide, polyethylenenaphthalene, a glass fiber, or a combination thereof.

11. The separator as claimed in claim 1, wherein, after leaving the separator at about 130° C. to about 150° C. for 60 minutes, measured average shrinkage rates in a machine direction and a transverse direction are less than or equal to about 20%.

12. A rechargeable lithium battery, comprising:
a positive electrode;
a negative electrode; and
the separator for a rechargeable lithium battery as claimed in claim 1 between the positive electrode and the negative electrode.
